(19) United States
(12) Patent Application Publication
(10) Pub. No.: US 2002/0055944 A1
(43) Pub. Date: May 9, 2002

(54) Transaction reconstruction

(76) Inventor: Jason Dyer, Bracknell (GB)

Correspondence Address: Edward A. Pennington, SWIDLER BERLIN SHEREFF FRIEDMAN, L.L.P., 3000 K Street, N.W., Suite 300, Washington, DC, 20007-5166, US

(21) Appl. No.: 09/730,731

(22) Filed: Dec. 7, 2000

(30) Foreign Application Priority Data
Sep. 18, 2000 (GB) 0022858.5

(51) Int. Cl. G06F 17/30

(52) U.S. Cl. 707/202

(57) ABSTRACT

The present invention relates to apparatus for reconstructing transactions applied to a first database. The first database is adapted to propagate the transactions to a second database and therefore includes a database processor adapted to apply received transactions to the first database, a store for storing details of the transactions, and an output for transferring the transaction details to the second database. The apparatus for reconstructing the transactions includes a reconstruction processor adapted to reconstruct at least one of the transactions. This is achieved by accessing the store to obtain the transaction details of the at least one transaction. The reconstruction processor then reconstructs the at least one transaction from the transaction details and outputs the reconstructed transaction(s).

### FIELD OF THE INVENTION

The present invention relates to apparatus and a method for reconstructing transactions applied to a database.

### DESCRIPTION OF THE PRIOR ART

In a replicated environment, such as a database system in which several identical databases are located at different sites, it is necessary to propagate transactions between the sites. Thus, for example if a first database is updated by modifying the data contained therein, then it is necessary to perform similar modification to the other databases to ensure that the databases remain identical.

In such systems, transactions modifying the data at a given site are applied to the site and then stored locally, before being transferred to other sites at a predetermined time. Thus, for example, databases located in different cites may be adapted to communicate with each other overnight to allow the transfer of transaction details therebetween. Once details of transactions apply to other databases have been received, the database receiving the transaction details will then update itself automatically.

However, in a replicated environment which has ceased to propagate transactions to other sites, it is often not possible to easily determine details about those transactions which have not yet been propagated.

In particular, in database applications, the only way to obtain information about the transactions applied to the database since the previous update is to examine internal views of the database. This information is generally in a very raw format (as will be shown in more detail below) which is extremely difficult for the database user to interpret, particularly when the number of transactions can run to tens of thousands between updates.

### SUMMARY OF THE INVENTION

In accordance with a first aspect of the present invention, we provide apparatus for reconstructing transactions applied to a first database, the first database being adapted to propagate the transactions to a second database, the first database including:

a. a database processor adapted to apply received transactions to the first database;

b. a store for storing details of the transactions;

c. an output for transferring the transaction details to the second database, the second database being automatically updated in accordance with the transaction details;

the apparatus comprising a reconstruction processor adapted to reconstruct at least one of the transactions applied to the first database by:

i. accessing the store to obtain the transaction details of the at least one transaction;

ii. reconstructing the at least one transaction from the transaction details;

iii. outputting the reconstructed transaction(s).

In accordance with a second aspect of the present invention, we provide a method of reconstructing at least one transaction applied to a first database, the first database being adapted to propagate the transactions to a second database, the first database including:

a. a database processor adapted to apply received transactions to the first database;

b. a store for storing details of the transactions;

c. an output for transferring the transaction details to the second database, the second database being automatically updated in accordance with the transaction details;

the method comprising:

i. accessing the store to obtain the transaction details of the at least one transaction;

ii. reconstructing the at least one transaction from the transaction details;

iii. outputting the reconstructed transaction(s).

Accordingly, the present invention provides a method and apparatus for reconstructing transactions applied to a database. The system operates by accessing a store which stores details of the transactions and then reconstructing the transactions themselves from the details. By reformulating the original transactions entered by the database user, it is easier for the user of the database to determine what transactions have been applied to the database than having to look in the store at the transaction details.

It should be noted that the process of reformulating or reconstructing the original transactions does not necessarily mean determining an identical transaction but rather means generating an equivalent to the original transaction.

Typically each transaction is formed from one or more associated calls, each call modifying data in accordance with a defined call type. In this case, the store is generally adapted to store a transaction queue indicating the transactions applied to the database; and, a call queue indicating the calls and call type for each transaction. The use of separate queues for the calls and the transactions is not however essential and will generally depend on the construction of the database under consideration.

In the situation in which separate queues are provided for the transactions and calls, the reconstruction processor is usually adapted to obtain the transaction details of a transaction by determining the transaction from the transaction queue; determining the one or more associated calls from the call queue; for each associated call, determining the call type from the call queue; and, for each associated call, determining the modifications made to the data in the database. The technique of obtaining the transaction details will however vary from database to database depending upon how the information is originally stored.

Typically the modifications made to the data in the database are determined in accordance with an argument value stored in the call queue. The argument value is used by internal functions within the database to retrieve an indication of the data which has been updated and the modification which was made. Again however this will vary depending on the database in question.

The transactions are usually received in SQL format, in which case the reconstructed transactions are output in SQL format. Other query languages may be used depending on the database, although in general, the format of the reconstructed transactions will be similar to that of the original transactions.

Typically the reconstruction processor is the database processor. This is particularly advantageous because the reconstruction processor can then utilize functions already provided in the database processor for propagating transactions to other databases. However, as an alternative, a separate processor may be provided in some circumstances, for example when the internal functions of the database processor do not allow the invention to be implemented.

The present invention also provides a database system comprising first and second databases the first database being adapted to propagate transactions to the second database; and, reconstructing apparatus according to the first aspect of the present invention, the reconstructing apparatus being designed to reconstruct at least any transactions not successfully from the first database to the second database. In this example, when the system fails so that data is not correctly propagated between the first and second databases the system can be adapted to reconstruct the transactions applied to the first database. This allows the user to determine the updates that have been applied to the first database. Furthermore, because the original transactions are reconstructed, the reconstructed transactions can then be applied to the second database causing the second database is to be updated.

The present invention also provides a list of one or more reconstructed transactions the transactions being reconstructed by apparatus according to the first aspect of the present invention.

### BRIEF DESCRIPTION OF THE DRAWINGS

An example of the present invention will now be described with reference to the accompanying drawing, in which:

FIG. 1 is a schematic diagram of a database system according to the present invention.

### DETAILED DESCRIPTION OF THE DRAWINGS

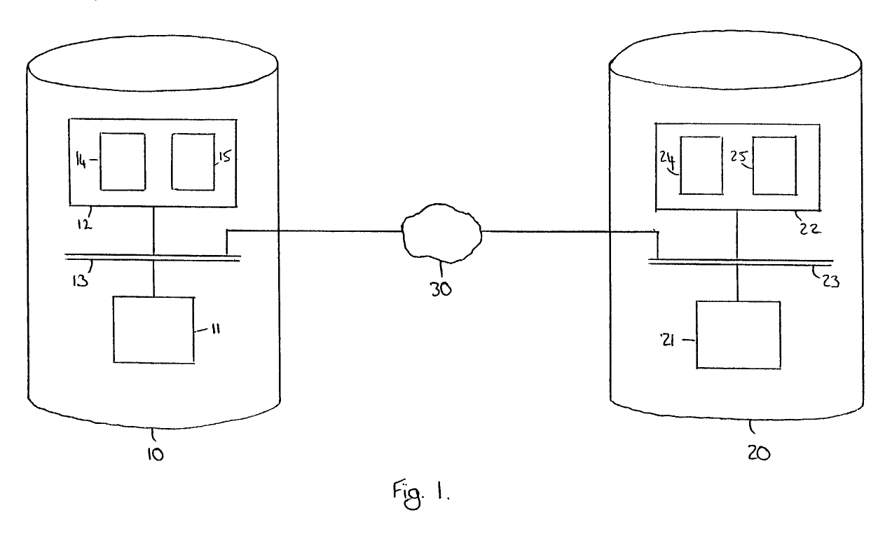

FIG. 1 shows an example of a distributed database system including the first and second databases 10,20. In this example the databases are interconnected via a communications medium 30, such as an Ethernet connection, a LAN, a WAN, the Internet or the like.

The database 10 includes a microprocessor 11 coupled to a memory 12 via a bus 13. The bus 13 is coupled to the communications medium 30 to allow data from the database 10, the microprocessor 11 and the memory 12 to be transferred to the other database 20. Similarly, the database 20 includes a microprocessor 21, store 22 and a bus 23.

In use, transactions received by the database 10 are transferred to the microprocessor 11 which causes data in the database 10 to be updated.

The data is typically stored in the database in the form of a number of database tables. Accordingly, the transactions will indicate which table should be updated together with an indication of the form of the update that should take place and the data which must be changed.

Each transaction typically consists of one or more calls, with each call operating to carry out a different update operation.

An example of the updating of a table will now be describe below with reference to table 1 which shows a typical department table for a companies database.

TABLE 1

| DEPTNO | DNANE | LOC |
|---|---|---|
| 10 | ACCOUNTING | NEW YORK |
| 20 | RESEARCH | DALLAS |
| 30 | SALES | CHICAGO |
| 40 | OPERATIONS | BOSTON |

where:
DEPT NO = department identifier number
DNAME = department name
LOC = department location

The transactions to be applied to the database 10 are as set out below:

| | |
|---|---|
| TRANSACTION 1 | |
| SQL> | insert into dept values |
| | (50, ‘SUPPORT’, ‘BRACKNELL’); |
| SQL> | insert into dept values |
| | (60, ‘ACCOUNTS’, ‘LONDON’) |
| SQL> | commit; |
| TRANSACTION 2 | |
| SQL> | update dept set |
| | LOC = ‘BRISTOL’ where deptno = 60; |
| SQL> | update dept set |
| | DNAME = ‘UNKNOWN’ where deptno > 40; |
| SQL> | delete from dept where deptno > 30; |
| SQL> | commit; |
| TRANSACTION 3 | |
| SQL> | insert into dept values |
| | (40, ‘OPERATIONS’, ‘BOSTON’) |
| SQL> commit; | |

Accordingly, transaction 1 consists of two calls each of which causes an additional row to be added to the table. Once the transaction 1 has been completed, the table will be as shown in table 2.

TABLE 2

| DEPTNO | DNAME | LOC |
|---|---|---|
| 10 | ACCOUNTING | NEW YORK |
| 20 | RESEARCH | DALLAS |
| 30 | SALES | CHICAGO |
| 40 | OPERATIONS | BOSTON |
| 50 | SUPPORT | BRACKNELL |
| 60 | ACCOUNTS | LONDON |

Transaction 2 includes three calls. The first call operates to change the location column for row 60, the second call operates to change the DNAME column for rows 50 and 60. The third call operates to delete from the DEPT table rows 40, 50 and 60. Accordingly, once transaction 2 has been applied to the table, the table appears as shown in table 3.

TABLE 3

| DEPTNO | DNAME | LOC |
|---|---|---|
| 10 | ACCOUNTING | NEW YORK |
| 20 | RESEARCH | DALLAS |
| 30 | SALES | CHICAGO |

Transaction 4 operates to create a new row 40 returning the table to its original state shown in table 1.

When these transactions are applied to the database 10, the microprocessor operates to generate a transaction queue 14 and a call queue 15 in the memory 12. An example of the transaction queue 14 for the transactions 1, 2, 3 set out above is shown in table 4. Similarly, an example of the call queue is shown in table 5.

TABLE 4

| DEFERRED_TRAN_ID | DELIVERY_ORDER ID | START_TIM |
|---|---|---|
| 4.4.23612 | 5.678E + 12R | 06-AUG-99 |
| 5.3.22924 | 5.678E + 12R | 06-AUG-99 |
| 5.17.22911 | 5.678E + 12R | 06-AUG-99 |

where:
DEFERRED_TRAN_ID = transaction identification number
DELIVERY_ORDER ID = delivery order identification number
START_TIM = start date of transaction

TABLE 5

| | DEFERRED_{—} | | |
|---|---|---|---|
| CALLNO | TRAN_ID | PROCNAME | ARGCOUNT |
| 1 | 4.4.23612 | REP_INSERT | 5 |
| 0 | 4.4.23612 | REP_INSERT | 5 |
| 0 | 5.3.22924 | REP_UPDATE | 9 |
| 1 | 5.3.22924 | REP_UPDATE | 9 |
| 2 | 5.3.22924 | REP_UPDATE | 9 |
| 3 | 5.3.22924 | REP_DELETE | 6 |
| 4 | 5.3.22924 | REP_DELETE | 6 |
| 5 | 5.3.22924 | REP_DELETE | 6 |
| 0 | 5.17.22911 | REP_INSERT | 5 |

where:
CALLNO = call number
DEFERRED_TRAN_ID = transaction identification number
PROCNAME = procedure name
ARGCOUNT = argument count value

Accordingly, the transaction queue 14 stores an indication of the transactions that were applied to the database, together with an indication of when the transaction was applied.

In contrast to this, the call queue 15, shown in table 5, stores an indication of the calls applied to the database for each transaction. The call number is set out in the CALLNO column with the identity of the transaction set out in the DEFERRED_TRAN_ID column. The type of call is set out in the PROCNAME column with an argument count set out in the ARGCOUNT column.

In normal operation, when the system operates to update the database 20 based on the amendments to the database 10, the microprocessor 11 operates to extract from the transaction queue 14 and call queue 15 basic details regarding the transactions. For each call of each transaction the microprocessor determines the type of call, together with an indication of the data that has changed. This information is extracted by the microprocessor 11 from the transaction queue 14 and a call queue 15 and transferred via the bus 13 and communications medium 30 to the microprocessor 21 of the database 20. The microprocessor 21 then operates to update the database 20 in the normal way.

In accordance with the present invention, however the microprocessor 11 is also adapted to regenerate transactions based on the transaction queue and the call queue. In order to achieve this, the microprocessor 11 uses the internal functions used in the propagation procedure described above to extract the details of the transactions applied to the database 10. In this case, given a particular call “c” (taken from the call queue) details of the transaction can be determined using the procedures:

dbms_defer_query.get_arg_type(“c” . . . )

dbms_defer_query.get_arg_form(“c” . . . )

Once executed these procedures return the type and form of the call, which together indicate that the call is of a particular data type (examples are VARCHAR2, CHAR, NUMBER—there are many types)

Once this has been determined one of the following procedures is executed to return the values for the call;

dbms_defer_query.get varchar2_arg(“c”, type, form . . . )

dbms_defer_query.get_number_arg(“C”, type, form . . . )

This allows the internal functions to be used to obtain information about the changed data.

Once this has been completed, the next stage is to determine what data has been updated. Replication often uses a primary key to uniquely identify the data that has been updated. Thus the primary key might be the DEPTNO column in the department table.

In this case using the term:

UPDATE DEPT SET LOC=“AAA” WHERE DEPTNO-10;

then the replication system knows at the other database it needs to update the data where DEPTNO=10.

For an update statement the microprocessor 11 extracts the OLD and NEW values using the dbms_defer_query package as above. So if the OLD value of LOC was “BBB” and the new value is “AAA” then the microprocessor 11 knows that when it propagates the data to the other side, then it has to change the LOC column from “BBB” to “AAA” where DEPTNO=10. This allows the old and new values to be determined for reconstruction of the update statement.

Thus the processor 11 determines the details that would normally be transferred to the other database 20, and then uses this information to reconstruct transactions as shown below.

Transaction id: 4.4.23612
INSERT INTO SCOTT.DEPT
(DEPTNO,
DNAME,
LOC)
VALUES
(50,
‘SUPPORT’,
‘BRACKNELL’);
INSERT INTO SCOTT.DEPT
(DEPTNO,
DNAME,
LOC)
VALUES
(60,
‘ACCOUNTS’,
‘LONDON’);
COMMIT;
Transaction id: 5.3.22924
UPDATE SCOTT.DEPT SET
LOC=‘BRISTOL’
WHERE
DEPTNO=60
AND DNAME=‘ACCOUNTS’
AND LOC=‘LONDON’;
UPDATE SCOTT.DEPT SET
DNAME=‘UNKNOWN’
WHERE
DEPTNO=50
AND DNAME=‘SUPPORT’
AND LOC ‘BRACKNELL’;
UPDATE SCOTT.DEPT SET
DNAME=‘UNKNOWN’
WHERE
DEPTNO=60
AND DNANE=‘ACCOUNTS’
AND LOC=‘BRISTOL’,
DELETE FROM SCOTT.DEPT WHERE
DEPTNO=40
AND DNAME=‘OPERATIONS’
AND LOC=‘BOSTON’;
DELETE FROM SCOTT.DEPT WHERE
DEPTNO=50
AND DNAME ‘UNKNOWN’
AND LOC=‘BRACKNELL’;
DELETE FROM SCOTT.DEPT WHERE
DEPTNO=60
AND DNAME=‘UKNOWN’
AND LOC=‘BRISTOL’;
COMMIT;
Transaction id: 5.17.22911
INSERT INTO SCOTT.DEPT
(DEPTNO,
DNAME,
LOC)
VALUES
(40,
‘OPERATIONS’,
‘BOSTON’);
COMMIT;

In this case, this allows the database user to determine which transactions were applied to the database 10. Transactions can also be output in the form of a text file which can then be transferred to the database 20 and applied to the database 20 as SQL in the normal manner.

It will be appreciated by a person skilled in the art that although the reconstructed transactions are not identical to the transactions as they were originally input, the transactions are in a similar format (i.e. they are also provided in SQL format) and are equivalent. Thus, if these transactions were applied to the first database, they would have exactly the same effect as the transactions that were originally applied.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

I claim:

1. Apparatus for reconstructing transactions applied to a first database, the first database being adapted to propagate the transactions to a second database, the first database including:
a. a database processor adapted to apply received transactions to the first database;
b. a store for storing details of the transactions;
c. an output for transferring the transaction details to the second database, the second database being automatically updated in accordance with the transaction details;
the apparatus comprising a reconstruction processor adapted to reconstruct at least one of the transactions applied to the first database by:
i. accessing the store to obtain the transaction details of the at least one transaction;
ii. reconstructing the at least one transaction from the transaction details;
iii. outputting the reconstructed transaction(s).

2. Apparatus according to claim 1, wherein each transaction is formed from one or more associated calls, each call modifying data in accordance with a defined call type, and wherein the store is adapted to store:
i. a transaction queue indicating the transactions applied to the database; and,
ii. a call queue indicating the calls and call type for each transaction.

3. Apparatus according to claim 2, wherein the reconstruction processor is adapted to obtain the transaction details of a transaction by:
i. determining the transaction from the transaction queue;
ii. determining the one or more associated calls from the call queue;
iii. for each associated call, determining the call type from the call queue; and,
iv. for each associated call, determining the modifications made to the data in the database.

4. Apparatus according to claim 3, wherein the modifications made to the data in the database are determined in accordance with an argument value stored in the call queue.

5. Apparatus according to claim 1, wherein the transaction are received in SQL format.

6. Apparatus according to claim 1, wherein the reconstructed transaction(s) are output in SQL format.

7. Apparatus according to claim 1, wherein the reconstruction processor is the database processor.

8. A database system comprising:
a. first and second databases, the first database being adapted to propagate transactions to the second database; and,
b. reconstructing apparatus according to claim 1, the reconstructing apparatus being designed to reconstruct at least any transactions not successfully transferred from the first database to the second database.

9. A list of one or more reconstructed transactions, the transactions being reconstructed by apparatus according to claims 1.

10. A method of reconstructing at least one transaction applied to a first database, the first database being adapted to propagate the transactions to a second database, the first database including:
a. a database processor adapted to apply received transactions to the first database;
b. a store for storing details of the transactions;
c. an output for transferring the transaction details to the second database, the second database being automatically updated in accordance with the transaction details;
the method comprising:
i. accessing the store to obtain the transaction details of the at least one transaction;
ii. reconstructing the at least one transaction from the transaction details;
iii. outputting the reconstructed transaction(s).

11. A method according to claim 10, wherein each transaction is formed from one or more associated calls, each call modifying data in accordance with a defined call type, and wherein the store is adapted to store:
a. a transaction queue indicating the transactions applied to the database; and,
b. a call queue indicating the calls and call type for each transaction;
the method obtaining the transaction details of a transaction comprising:
i. determining the transaction from the transaction queue;
ii. determine the one or more associated calls from the call queue;
iii. for each associated call, determine the call type from the call queue;
iv. for each associated call, determine the modifications made to the data in the database.

12. A method according to claim 10, wherein the method comprises causing the database processor to reconstruct the transaction(s).

13. A list of one or more reconstructed transactions, the transactions being reconstructed in accordance with the method of claim 10.
